(19) United States
(12) Patent Application Publication
(10) Pub. No.: US 2007/0208583 A1
(43) Pub. Date: Sep. 6, 2007

(54) Computing popularity based upon subscriptions

(75) Inventor: Alan Ward, Thornton, CO (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/366,321

(22) Filed: Mar. 1, 2006

(51) Int. Cl. G06Q 10/00; G06Q 30/00

(52) U.S. Cl. 705/1

(57) ABSTRACT

Computing the popularity of a source of serial online content based upon a number of subscriptions to the source of serial online content is disclosed. In some embodiments, upon receiving an indication that a subscription to a source of serial online content has been requested, a popularity score for the source of serial online content is computed based at least in part on a decayed count of subscriptions to the source of serial online content over a prescribed time period. In some embodiments, the computation of the popularity score includes time decaying the count of subscriptions by multiplying by a decay factor at prescribed time intervals. In some embodiments, the popularity scores of a plurality of sources of serial online content are sorted and ranked, to generate, for example, a listing of the most popular sources of serial online content.

### BACKGROUND OF THE INVENTION

Typical techniques for computing the popularity of a content item are based at least in part upon a count associated with the number of times the content item has been selected, purchased, and/or downloaded by a user. However, some sources of online content, such as web feeds and podcasts, include multiple parts, each of which may be available at different points in time. In such cases, a third party other than a supplier of the source of online content, such as one that makes subscriptions to one or more such sources available but is not itself otherwise affiliated with such source(s), may not have access to the information required to compute the popularity of such a source of online content based upon the numbers of times various content associated with the source of online content is downloaded. Thus, there is a need for a manner to compute the popularity of a source of online content that does not require access to information concerning whether and/or which specific items of content associated with the source of online content have been downloaded.

### BRIEF DESCRIPTION OF THE DRAWINGS

Various embodiments of the invention are disclosed in the following detailed description and the accompanying drawings.

FIG. 1 illustrates an embodiment of a network environment in which a client may subscribe to a source of serial online content, such as a podcast.

FIG. 2 illustrates an embodiment of a process for determining the popularity of a source of serial online content.

FIG. 3 illustrates an embodiment of a data structure used to store the decayed popularities of one or more sources of serial online content.

FIG. 4 illustrates an embodiment of a process for updating the decayed popularities of one or more sources of serial online content.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Computing the popularity of a source of serial online content based upon a number of subscriptions to the source of serial online content is disclosed. In some embodiments, upon receiving an indication that a subscription to a source of serial online content has been requested, a popularity score for the source of serial online content is computed based at least in part on a decayed count of subscriptions to the source of serial online content over a prescribed time period. In some embodiments, the computation of the popularity score includes time decaying the count of subscriptions by multiplying by a decay factor at prescribed time intervals. In some embodiments, the popularity scores of a plurality of sources of serial online content are sorted and ranked, to generate, for example, a listing of the most popular sources of serial online content.

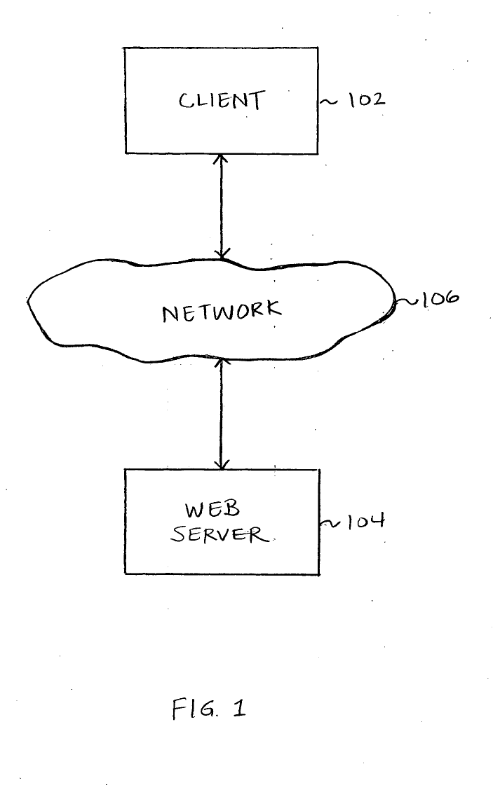

FIG. 1 illustrates an embodiment of a network environment in which a client may subscribe to a source of serial online content, such as a podcast. As used herein, the term “source of serial online content” refers to a logical entity, grouping, or source established to make serial content available for download, e.g., via the Internet, such as a podcast or weblog, or any RSS, XML, or other “feed” of online content. A single content provider and/or physical server may in some cases be associated with and/or comprise multiple sources of serial online content to which subscribers may subscribe individually. The term “serial” as used herein refers to content that is created, provided, downloaded, made available, posted, etc. in segments, such as episodes, over time. For example, in some cases the entire series of content may be created first, and segments or episodes may be made available for download sequentially over a period of time, e.g., a new episode may be released every week.

In the example shown in FIG. 1, client 102 communicates with web server 104 via a network 106. Network 106 may correspond to any internal or external network, such as a LAN, WAN, the internet, etc. Web server 104 may provide access to one or more sources of serial online content to which a client, such as client 102, may subscribe. In some embodiments, subscriptions to one or more sources of serial online content are free of charge. Sources of serial online content to which web server 104 provides access and/or subscriptions to may be produced at web server 104, may be produced by an internally affiliated content provider, or may be produced and/or syndicated by an external content provider. Thus, in some embodiments, web server 104 is a third party that is not the producer or supplier of one or more sources of serial online content but provides subscriptions to one or more sources of serial online content produced and supplied by another content provider. In some embodiments, web server 104 includes a cataloged listing of sources of serial online content, for example, via one or more menus, which a user of client 102 may peruse through and employ to subscribe to one or more desired sources of serial online content.

Sources of serial online content to which client 102 may subscribe include, for example, podcasts, radio shows or programs, television series, weblogs, news programs, news columns, opinion columns, discussion threads, other episodic media that are periodically updated or serially produced, etc. Content associated with sources of serial online content may include audio, video, animation, graphics, image, text, or any other appropriate file format or type used to the represent the content. In some embodiments, a source of serial online content to which client 102 subscribes via web server 104 comprises a web feed. In some emobidments, web server 104 facilitates subscriptions to one or more web feeds in one or more appropriate web feed formats, such as XML (extensible Markup Language), RSS (RDF or Rich Site Summary), Atom, etc. In some embodiments, a count is maintained of the number of times a source of serial online content is subscribed to by different clients (i.e., unique requesting clients, such that multiple subscriptions by the same client are counted only the first time). Such a count may be used at least in part to determine the popularity of the source of serial online content.

As used herein, the “client”, “user”, or “subscriber” that subscribes to a source of serial online content may correspond to a person, process, and/or machine. A client may automatically request and/or receive new content associated with a source of serial online content, for example, periodically or as the new content becomes available, or a client or user may choose to manually determine when to receive new content from a source of serial online content. In some embodiments, a client may receive alerts or notifications indicating that new content is available from a source of serial online content, and the client or user of the client may accordingly determine when, if ever, to request any of the new content from the source of serial online content.

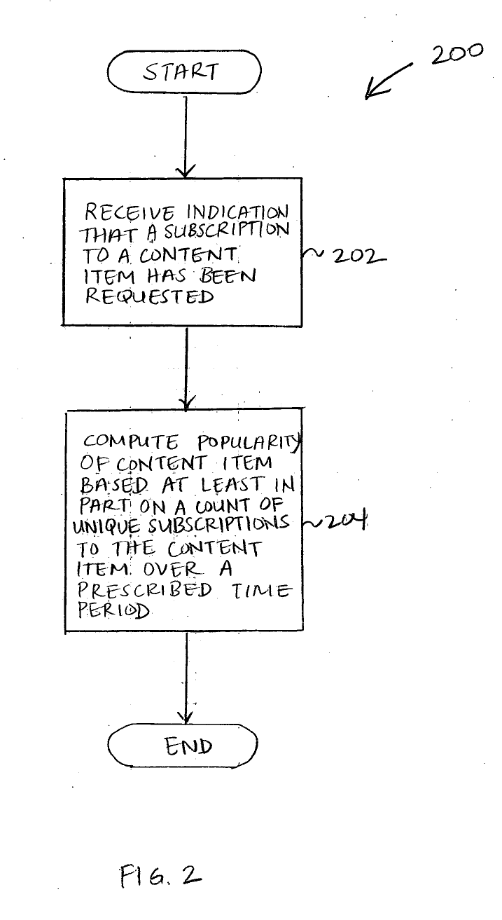

FIG. 2 illustrates an embodiment of a process for determining the popularity of a source of serial online content. In some embodiments, process 200 is employed by a web server, such as web server 104 of FIG. 1, that offers subscriptions to one or more sources of serial online content and/or by another processing device associated with such a web server such as a backend server. Process 200 begins at 202 at which an indication is received that a subscription to a source of serial online content has been requested. The indication of 202 may be received, for example, when a user of a client, such as client 102 of FIG. 1, subscribes to a source of serial online content, for example, by clicking on an associated subscription button. At 204, the popularity of the source of serial online content is computed based at least in part on a count of unique subscriptions to the source of serial online content over a prescribed time period, after which process 200 ends.

The popularity of a source of serial online content may be based at least in part on a count associated with the source of serial online content. For example, in some embodiments, each time a source of serial online content is subscribed to, a count associated with the source of serial online content is incremented by a predetermined amount (e.g., by one). In some embodiments, the count is not incremented immediately at the time a source of serial online content is subscribed to but instead subscriptions over a predetermined period of time are aggregated and added to the count as a lump sum. For example, at the end of a given day, the number of subscriptions to a specific source of serial online content on that day may be added to a count that represents the cumulative number of subscriptions to the source of serial online content before that day.

In some embodiments, the popularity of a source of serial online content is computed by adjusting the count of subscriptions of the source of serial online content by a factor in order to take into account variation of popularity over one or more variables, such as time, location, etc. In some embodiments, the popularity of a source of serial online content is computed by decaying or discounting the count of subscriptions of the source of serial online content by a factor for each passage of a predetermined period of time so that the popularity is biased towards more recent increments of the count. In some embodiments, the factor is between zero and one, inclusive. A factor of zero resets the count, and a factor of one imparts equal weights to each increment of the count. In some embodiments, a factor of 0.7 is used to calculate a decayed popularity and is applied, e.g., at the end of each day. Equation (1) gives an example of a manner in which a decayed popularity may be computed.
dp=dp_old*factor+current_period_count (1)

In Equation (1), dp represents decayed popularity; dp_old represents the decayed popularity as of the end of a prior decay period (e.g., at the end of the previous day, for a popularity decayed once nightly), and current_period_count represents a count (e.g., sum) of the number of subscriptions to the source of serial online content since the end of the prior decay period (i.e., since dp_old was computed).

One effect of Equation (1) is that events from earlier decay periods are decayed relative to events from more recent periods, since the factor is applied to the overall popularity at the end of each period. For example, suppose that the decay period corresponds to a day, that factor is 0.7, and that dp is based upon the number of subscriptions to a source of serial online content per day. In this example, when computing the decayed popularity, today's subscriptions each count for 1.0, yesterday's subscriptions each count for 0.7, . . . , subscriptions from five days ago each count for 0.16807 (because the effect of Equation (1) would be to have discounted them each of five days by a factor of 0.7, i.e., 0.7ˆ5), etc. Thus, the decayed popularity provides a moving average popularity measure where only the last two or three days'subscriptions are really significant.

The popularity of a source of serial online content may fluctuate over time. The decay factor is selected to ensure that the most relevant information influences the computed popularity to an appropriate degree. For example, for sources of serial online content that experience great variation in popularity over time, a decay factor of 0.7 and a decay period of one day result in subscription events having a “half life” of two days in terms of their effect on computed popularity (because every two days a subscription event is decayed by 0.7*0.7=0.49 or about half), which results in the computed popularity being determined primarily, or at least most significantly, by the events (e.g., subscriptions) of the past two days and popularity decaying relatively rapidly for a source of serial online content that experiences a drop in subscription activity. Decayed popularity offers a way to determine how popular a source of serial online content is in the present as opposed to how popular the source of serial online content has been in the past. In some embodiments, the extent to which the decayed popularity of a source of serial online content captures the past depends upon the time frame over which the decayed popularity is computed. The selection of such a time frame may be dependent on the source of serial online content. In some embodiments, a decayed popularity is computed over a moving window of a prescribed length of time, such that subscriptions requested at a time outside the window are not included in an associated subscription count.

In some embodiments, the count of subscriptions to a source of serial online content is incremented only once per unique requesting client in order to prevent, for example, a particular client from rigging the popularity of the source of serial online content by subscribing to it multiple times. In the cases where a subscription requires a user to log-in to an associated application in order to subscribe to a desired source of serial online content, the count of subscriptions to the source of serial online content is, in some embodiments, incremented only once per username, such as the first time a subscriber with a given username subscribes to the source of serial online content. In some embodiments, the count of subscriptions to a source of serial online content is incremented once per IP (Internet Protocol) address. In various embodiments, when determining whether to increment the count of subscriptions to a source of serial online content, the uniqueness of a subscription may be determined by a subscriber identifier (e.g., username), IP address, and/or any other appropriate identifier.

In some embodiments, the count of subscriptions to a source of serial online content is periodically reset. In some such embodiments, even after the count of subscriptions to a source of serial online content has been reset, a subsequent subscription to the source of serial online content by a client that has previously subscribed to the source of serial online content is not used to further increment the count. In some embodiments, a future subscription by a client that has previously subscribed to a source of serial online content is used to increment the subscription count only if the future subscription occurs a prescribed period of time after the last subscription by the client. Such a case may arise, for example, if a particular client subscribes to a source of serial online content, later unsubscribes to the source of serial online content, and at a future time subscribes to the source of serial online content again. Such behavior by a client may be based, for example, on the fluctuation of popularity of the source of serial online content, and in such cases, it may be desirable to increment the count of subscriptions to the source of serial online content even if the client has previously subscribed to the source of serial online content.

In some embodiments, an unsubscribe event is similarly monitored, recorded, and/or employed in computing the popularity of a source of serial online content. In some embodiments, when a client unsubscribes, the subscription count of the source of serial online content is decremented by a predetermined amount (e.g., by one). In such cases, when computing decayed popularity using Equation 1, for example, current_period_count in some embodiments represents the total number of times a source of serial online content has been subscribed to less the number of times the source of serial online content has been unsubscribed since the last decay period. In some embodiments, at least within a prescribed time period, the count of a source of serial online content is decremented only once per unsubscribe event per client, which in various embodiments is identified by username, IP address, etc., at the time of the unsubscribe request.

In some embodiments, the decayed popularity of a source of serial online content is employed to rank the source of serial online content relative to other sources of serial online content. For instance, in some embodiments, the decayed popularities of one or more sources of serial online content are computed regularly and employed to sort or rank the sources of serial online content, for example, from most popular to least popular. A ranking, such as a top ten list, is determined for a set of one or more sources of serial online content and presented, for example, by a web server that offers subscriptions to sources of serial online content, such as web server 104 of FIG. 1. Rankings may be separately determined for different types of sources of serial online content or may be collectively determined for one or more different types of sources of serial online content. In some embodiments, sources of serial online content are ranked by genre, and rankings are determined within each genre in addition to or instead of rankings across one or more genres.

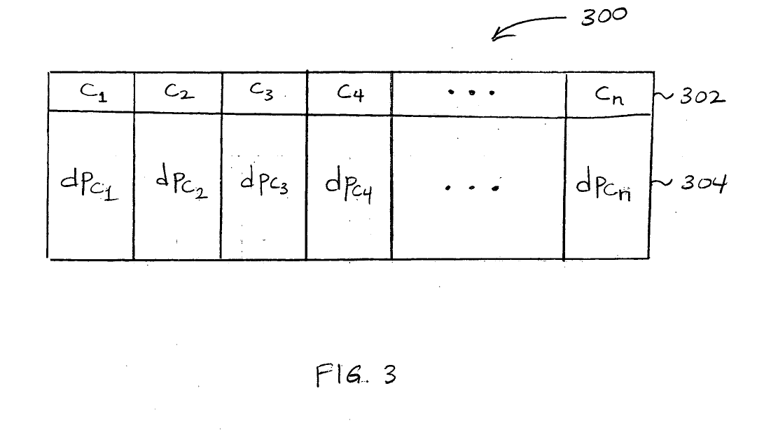

The decayed popularities of one or more sources of serial online content may be stored in an appropriate data structure. FIG. 3 illustrates an embodiment of a data structure used to store the decayed popularities of one or more sources of serial online content. In some embodiments, data structure 300 is associated with web server 104 of FIG. 1. In the given example, each source of serial online content (C) 302 is associated with a corresponding decayed popularity (dp) 304. In some embodiments, a source of serial online content and its corresponding decayed popularity is purged or removed from data structure 300 if the source of serial online content has not been subscribed to for a prescribed period of time and/or if its decayed popularity falls below a threshold value.

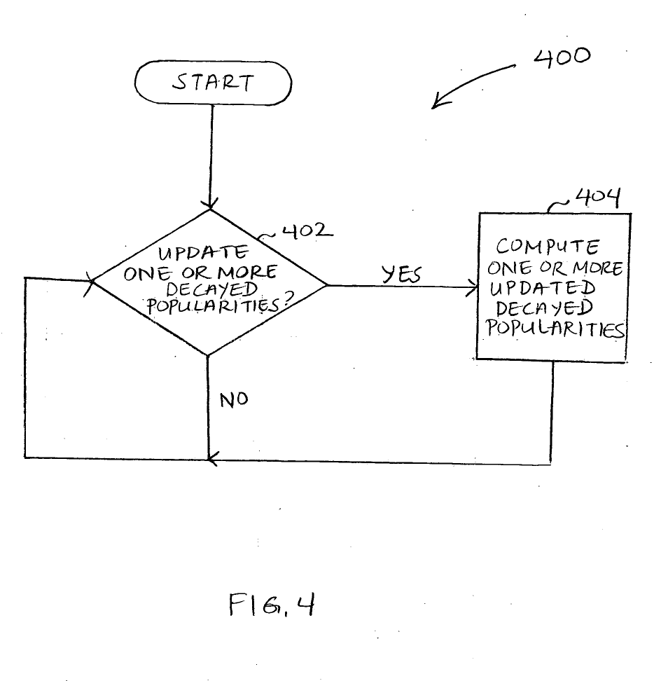

FIG. 4 illustrates an embodiment of a process for updating the decayed popularities of one or more sources of serial online content. In some embodiments, process 400 is employed to update one or more of the decayed popularities (e.g., 304) stored in data structure 300 of FIG. 3. At 402 it is determined whether to update one or more decayed popularities. In some embodiments, one or more decayed popularities are periodically updated, and it is determined at 402 whether the time to update has arrived. In some embodiments, each time a source of serial online content is subscribed to (e.g., at 202 of FIG. 2), its decayed popularity is dynamically updated. Therefore, in some embodiments, an indication is received at 402 that a source of serial online content has been subscribed to by a client. In some embodiments, the decayed popularity of a source of serial online content is periodically or dynamically updated for each time the source of serial online content is unsubscribed, and an appropriate indication is received at 402 for each time the source of serial online content is unsubscribed. If it is determined at 402 to update one or more decayed popularities, one or more updated decayed popularities are computed at 404, and subsequently process 400 returns to 402 to continue determining whether one or more decayed popularities need to be updated. In some embodiments, Equation (1) is used to compute the one or more updated decayed popularities at 404. If it is determined at 402 not to update one or more decayed popularities, process 400 returns to 402 to continue determining whether one or more decayed popularities need to be updated. In some embodiments, a decayed popularity is updated (e.g., incremented) each time a source of serial online content is subscribed to, but decayed, e.g., by applying Equation (1), only periodically. In some embodiments, a decayed popularity is updated (e.g., decremented) each time a source of serial online content is unsubscribed, but decayed, e.g., by applying Equation (1), only periodically. In some embodiments, each time one or more decayed popularities are updated at 404, the decayed popularity scores of one or more sources of serial online content are sorted so that the a proper ranking of the sources of serial online content can be determined and presented.

In some embodiments, based upon one or more sources of serial online content subscribed to by a user, it may be desirable to recommend other sources of serial online content to the user for consideration. In some embodiments, a recommendation of a source of serial online content is based upon the degree of similarity between the recommended source of serial online content and the subscribed source of serial online content. In some embodiments, a count of the number of times a pair of sources of serial online content has been subscribed to by a single user, possibly within a prescribed sliding window, is weighted by the decayed popularities of the sources of serial online content comprising the pair to compute the similarity score of the pair. In some embodiments, a similarity score is computed by dividing the pair count by the square root of the sum of the squares of the decayed popularities of the sources of serial online content comprising the pair. In some embodiments, when a specific source of serial online content is subscribed to by a user, the similarities of the subscribed source of serial online content to other sources of serial online content with which it forms pairs (i.e. because both sources of serial online content in the pair of sources of serial online content have been subscribed to by one or more users within a prescribed time period) are determined, and the one or more sources of serial online content that result in high similarities with the subscribed source of serial online content are recommended to the subscriber. Although recommendations of other sources of serial online content have been described, similar techniques may be employed to recommend other types of content or content items to a user who has subscribed to a particular source of serial online content.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for determining popularity of a source of serial online content, comprising:
receiving an indication that a subscription to a source of serial online content has been requested; and
computing a popularity score for the source of serial online content based at least in part on a decayed count of subscriptions to the source of serial online content over a prescribed time period.

2. A method as recited in claim 1, wherein the source of serial online content comprises a web feed.

3. A method as recited in claim 1, wherein the source of serial online content comprises a podcast.

4. A method as recited in claim 1, wherein the source of serial online content comprises a series of episodes.

5. A method as recited in claim 4, wherein the series of episodes comprises one or more of television series, a radio show, a news program, a news column, an opinion column, a weblog, and a discussion thread.

6. A method as recited in claim 1, wherein receiving an indication that a subscription to a source of serial online content has been requested includes determining that the subscription is being requested by a unique subscriber, a unique IP address, or both.

7. A method as recited in claim 1, wherein receiving an indication that a subscription to a source of serial online content has been requested includes determining that the requestor has not requested a subscription to the source of serial online content at least within a prescribed period of time in the past.

8. A method as recited in claim 1, wherein the count of subscriptions is incremented by a predetermined amount for each unique subscription.

9. A method as recited in claim 1, wherein computing a popularity score for the source of serial online content based at least in part on a decayed count of subscriptions to the source of serial online content over a prescribed time period comprises time decaying the count of subscriptions by multiplying by a decay factor at prescribed time intervals.

10. A method as recited in claim 9, wherein the decay factor has a value between zero and one, inclusive.

11. A method as recited in claim 1, wherein the prescribed time period comprises a moving window of a prescribed length of time.

12. A method as recited in claim 1, further comprising ranking the source of serial online content relative to other sources of serial online content based at least in part on the popularity score of the source of serial online content.

13. A method as recited in claim 1, wherein the count of subscriptions is decremented by a predetermined amount each time the source of serial online content is unsubscribed.

14. A method as recited in claim 1, wherein the source of serial online content is a first source of serial online content and further comprising recommending a second source of serial online content to the subscriber of the first source of serial online content based at least in part on a degree of similarity of the second source of serial online content to the first source of serial online content.

15. A method as recited in claim 1, wherein the subscription is free of charge.

16. A method as recited in claim 1, wherein the subscription is requested from a third party that is not the producer of the source of serial online content.

17. A method as recited in claim 1, wherein the source of serial online content is part of a plurality of sources of serial online content made available by a third party that is not the producer of one or more of the plurality of sources of serial online content.

18. A system for determining popularity of a source of serial online content, comprising:
a processor configured to:
receive an indication that a subscription to a source of serial online content has been requested; and
compute a popularity score for the source of serial online content based at least in part on a decayed count of subscriptions to the source of serial online content over a prescribed time period; and
a memory coupled to the processor and configured to provide instructions to the processor.

19. A system as recited in claim 18, wherein to compute a popularity score for the source of serial online content based at least in part on a decayed count of subscriptions to the source of serial online content over a prescribed time period comprises time decaying the count of subscriptions by multiplying by a decay factor at prescribed time intervals.

20. A computer program product for determining popularity of a source of serial online content, the computer program product being embodied in a computer readable medium and comprising computer instructions for:
receiving an indication that a subscription to a source of serial online content has been requested; and
computing a popularity score for the source of serial online content based at least in part on a decayed count of subscriptions to the source of serial online content over a prescribed time period.
